(19) United States
(12) Patent Application Publication
(10) Pub. No.: US 2026/0186335 A1
(43) Pub. Date: Jul. 2, 2026

(54) DISPLAY DEVICE INCLUDING NONPOLAR LIQUID

(71) Applicant: KOREA ELECTRONICS TECHNOLOGY INSTITUTE, Seongnam-si (KR)

(72) Inventor: Soon Hyung KWON, Seongnam-si (KR)

(21) Appl. No.: 19/309,911

(22) Filed: Aug. 26, 2025

(30) Foreign Application Priority Data
Dec. 26, 2024 (KR) 10-2024-0197530
Jan. 20, 2025 (KR) 10-2025-0008284

(51) Int. Cl. G02F 1/1333; G02F 1/1339; G02F 1/1343

(52) U.S. Cl. CPC G02F 1/133337; G02F 1/133331; G02F 1/1339; G02F 1/134309

(57) ABSTRACT

Disclosed is a display device including a nonpolar liquid to improve the visibility of a display panel. The display device includes a display panel, a cover window spaced apart from the display panel by a predetermined gap, and a nonpolar liquid positioned between the display panel and the cover window.

### CROSS REFERENCE TO RELATED APPLICATION

The present application claims priority to Korean Patent Application No. 10-2024-0197530, filed Dec. 26, 2024, and Korean Patent Application No. 10-2025-0008284, filed Jan. 20, 2025, the entire contents of which are incorporated herein for all purposes by this reference.

### TECHNICAL FIELD

The present disclosure relates to a display device including a nonpolar liquid.

### BACKGROUND

Display devices employ various types of display technologies, such as a liquid crystal display (LCD), an organic light emitting diode (OLED), a plasma display panel (PDP), and an electrophoretic display. Such a display device includes a display panel configured to display information and a cover window coupled to the display panel to protect the display panel. An air gap may be defined between the display panel and the cover window. A difference in refractive index between the cover window, the air gap, and the display panel may cause visibility degradation.

### SUMMARY

An aspect of the present disclosure is to provide a display device including a nonpolar liquid between a display panel and a cover window.

Another aspect of the present disclosure is to provide a display device in which an oleophilic region and an oleophobic region are formed between the display panel and the cover window to restrict the location of the nonpolar liquid.

A further aspect of the present disclosure is to provide a display device that further includes a sealing portion configured to prevent the nonpolar liquid between the display panel and the cover window from flowing due to gravity.

In accordance with an aspect of the present disclosure, a display device including a nonpolar liquid includes a display panel, a cover window spaced apart from the display panel by a predetermined gap, and a nonpolar liquid positioned between the display panel and the cover window.

According to an embodiment, the display device including a nonpolar liquid may further include a case configured to accommodate and fix the display panel and the cover window so as to maintain the predetermined gap between the display panel and the cover window.

According to an embodiment, the case may include a lower case configured to fix the display panel and a side case connected to the lower case and configured to fix the cover window.

According to an embodiment, the case may further include a case bezel connected to the side case and configured to cover a panel bezel corresponding to an edge of an active area of the display panel so as to prevent exposure of the panel bezel to the outside.

According to an embodiment, the nonpolar liquid may be positioned in a region larger than an active area of the display panel but smaller than the display panel.

According to an embodiment, the display device including a nonpolar liquid may further include a bezel coating formed at an edge of the cover window and configured to cover a panel bezel corresponding to an edge of an active area of the display panel so as to prevent exposure of the panel bezel to the outside.

According to an embodiment, the display device including a nonpolar liquid may further include an oleophobic region formed by coating an oleophobic material along an edge of a region configured to receive the nonpolar liquid between the display panel and the cover window.

According to an embodiment, the oleophobic region may be formed on an upper surface of the display panel, on a lower surface of the cover window, or on both the upper surface of the display panel and the lower surface of the cover window.

According to an embodiment, the display device including a nonpolar liquid may further include an oleophilic region formed by coating an oleophilic material in a region configured to receive the nonpolar liquid between the display panel and the cover window.

According to an embodiment, the oleophilic region may be formed on an upper surface of the display panel, on a lower surface of the cover window, or on both the upper surface of the display panel and the lower surface of the cover window.

According to an embodiment, the display device including a nonpolar liquid may further include an oleophobic region formed by coating an oleophobic material along an edge of a region configured to receive the nonpolar liquid between the display panel and the cover window and an oleophilic region formed by coating an oleophilic material in a region configured to receive the nonpolar liquid on surfaces of the display panel and the cover window facing each other.

According to an embodiment, the display device including a nonpolar liquid may further include a guard configured to prevent leakage of the nonpolar liquid and formed along a lower edge of a region having the nonpolar liquid positioned therein based on the direction of gravity and along at least a portion of lateral edges of the region.

According to an embodiment, the guard may have a height determined to prevent the nonpolar liquid from leaking through a region not blocked by the guard due to gravity.

According to an embodiment, the guard may be formed along a lower side and lateral sides of the display panel based on a top and bottom orientation defined according to intended use of the display panel, and may not be formed along an upper side of the display panel.

According to an embodiment, the guard may be formed to connect a side surface of the display panel to a lower surface of the cover window, and may not be formed between the display panel and the cover window.

According to an embodiment, the display device including a nonpolar liquid may further include a plurality of guides connected to a lower surface of the cover window and in contact with an edge of the display panel to guide a relative position between the display panel and the cover window.

According to an embodiment, the display panel may include a lower substrate, a lower electrode layer formed on the lower substrate, a display layer formed on the lower electrode layer and configured to display information through movement of electrophoretic particles, an upper electrode layer formed on the display layer, and an upper substrate formed on the upper electrode layer.

In accordance with another aspect of the present disclosure, a method of manufacturing a display device including a nonpolar liquid includes preparing a display panel including an active area configured to display information and a bezel surrounding the active area, preparing a cover window, applying a nonpolar liquid to a lower surface of the cover window, coupling the cover window and the display panel to allow the nonpolar liquid to be positioned between a lower surface of the cover window and an upper surface of the display panel, and assembling a case to accommodate the cover window and the display panel.

According to an embodiment, the method may further include, before coupling the cover window and the display panel, forming an oleophobic region by coating an oleophobic material on the lower surface of the cover window or on the upper surface of the display panel so as to surround a region configured to receive the nonpolar liquid.

According to an embodiment, the method may further include, before coupling the cover window and the display panel, forming an oleophilic region by coating an oleophilic material in a region configured to receive the nonpolar liquid on the lower surface of the cover window or the upper surface of the display panel.

According to an embodiment, the method may further include, after coupling the cover window and the display panel, forming a guard configured to connect the lower surface of the cover window to a side surface of the display panel.

According to an embodiment, forming the guard may include forming the guard along a lower side and lateral sides of the display panel based on a top and bottom orientation defined according to intended use of the display panel without forming the guard along an upper side of the display panel.

The features and advantages of the present disclosure will become more obvious from the following detailed description provided with reference to the accompanying drawings.

Before explaining embodiments of the present disclosure, it is to be understood that the phraseology and terminology used in the following specification and appended claims should not be construed as limited to general and dictionary meanings but be construed as having meanings and concepts according to the spirit of the present disclosure on the basis of the principle that the inventor is permitted to define appropriate terms for the best explanation.

### BRIEF DESCRIPTION OF THE DRAWINGS

The above and other aspects, features, and other advantages of the present disclosure will be more clearly understood from the following detailed description taken in conjunction with the accompanying drawings, in which:

FIG. 1 is a view showing a display device including a nonpolar liquid according to an embodiment;

FIG. 2 is a view showing a change in the volume of the nonpolar liquid in the display device;

FIG. 3 is a view showing a display panel according to an embodiment;

FIG. 4 is a plan view of the display device including a nonpolar liquid according to the embodiment;

FIG. 5 is a cross-sectional view taken along line A-A′ in FIG. 4 to show a structure in which a side surface of the display panel is spaced apart from a side case;

FIG. 6 is a cross-sectional view taken along line A-A′ in FIG. 4 to show a structure in which the side surface of the display panel is in contact with the side case;

FIG. 7 is a cross-sectional view taken along line A-A′ in FIG. 4 to show a case including a case bezel;

FIG. 8 is a plan view showing an oleophobic region of the display device including a nonpolar liquid according to the embodiment;

FIG. 9 is a cross-sectional view taken along line B-B′ in FIG. 8;

FIG. 10 is a plan view showing an oleophilic region of the display device including a nonpolar liquid according to the embodiment;

FIG. 11 is a cross-sectional view taken along line C-C′ in FIG. 10;

FIG. 12 is a plan view showing the oleophobic region and the oleophilic region of the display device including a nonpolar liquid according to the embodiment;

FIG. 13 is a cross-sectional view taken along line D-D′ in FIG. 12;

FIG. 14 is a plan view showing a structure in which a guard is spaced apart from the nonpolar liquid in the display device including a nonpolar liquid according to the embodiment;

FIG. 15 is a cross-sectional view taken along line E-E′ in FIG. 14;

FIG. 16 is a cross-sectional view taken along line F-F′ in FIG. 14;

FIG. 17 is a cross-sectional view taken along line G-G′ in FIG. 14;

FIG. 18 is a plan view showing a structure in which the guard is in contact with the nonpolar liquid in the display device including a nonpolar liquid according to the embodiment;

FIG. 19 is a cross-sectional view taken along line H-H′ in FIG. 18;

FIG. 20 is a cross-sectional view taken along line I-I′ in FIG. 18;

FIG. 21 is an exploded perspective view showing a guide of the display device including a nonpolar liquid according to the embodiment;

FIG. 22 is a plan view showing the guide of the display device including a nonpolar liquid according to the embodiment;

FIG. 23 is a cross-sectional view taken along line J-J′ in FIG. 22;

FIG. 24 is a cross-sectional view showing a power supply of the display device including a nonpolar liquid according to the embodiment;

FIG. 25 is a cross-sectional view showing some steps of a method of manufacturing the display device including a nonpolar liquid according to an embodiment;

FIG. 26 is a cross-sectional view showing some steps of a method of manufacturing the display device including a nonpolar liquid according to the embodiment, which further includes the guard;

FIG. 27 is a cross-sectional view showing some steps of a method of manufacturing the display device including a nonpolar liquid according to the embodiment, which includes the oleophobic region and the oleophilic region; and

FIG. 28 is a cross-sectional view showing some steps of a method of manufacturing the display device including a nonpolar liquid according to the embodiment, which includes the guard, the oleophobic region, and the oleophilic region.

### DETAILED DESCRIPTION

Hereinafter, exemplary embodiments of the present disclosure will be described in detail with reference to the accompanying drawings. However, the exemplary embodiments of the present disclosure to be described below are provided by way of example, and the present disclosure is not limited to the exemplary embodiments set forth herein.

Hereinafter, an embodiment of the present disclosure will be described in detail with reference to the accompanying drawings.

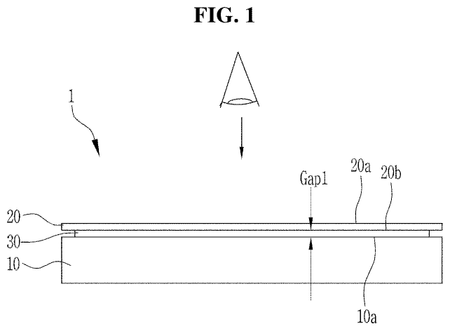

FIG. 1 is a view showing a display device 1 including a nonpolar liquid 30 according to an embodiment.

The display device 1 including the nonpolar liquid 30 may include a display panel 10, a cover window 20 spaced apart from the display panel 10 by a predetermined gap Gap1, and the nonpolar liquid 30 disposed between the display panel 10 and the cover window 20. In the present disclosure, the display device 1 including the nonpolar liquid 30 may be briefly referred to as the display device 1.

The display panel 10 may display letters, numerals, symbols, images, colors, videos, or other types of information. The display panel 10 may include a light reflective type panel such as an electrophoretic display, an electrochromic display, an electrowetting display, a toner display, or a reflective liquid crystal display, and may also include a light emissive type display such as an LCD, a PDP, an OLED, an LED, or a QD-LED.

The cover window 20 may be positioned at an outermost portion of the display device 1 in order to protect the display panel 10. Information may be displayed through an upper surface 20a of the cover window 20. The cover window 20 may include a glass plate or a synthetic resin plate that protects the display panel 10. The cover window 20 may prevent the display panel 10 from being directly impacted by external force. The cover window 20 may also prevent moisture or contaminants from directly reaching the display panel 10. The cover window 20 may be spaced apart from the display panel 10 by the predetermined gap Gap1.

The nonpolar liquid 30 may be positioned between the cover window 20 and the display panel 10. The nonpolar liquid 30 may be a liquid that is not soluble in water and has no polarity. The nonpolar liquid 30 may include hexane, benzene, toluene, chloroform, or various oils. The nonpolar liquid 30 may be in contact with a lower surface 20b of the cover window 20 and an upper surface 10a of the display panel 10. If the gap Gap1 between the cover window 20 and the display panel 10 is very small, forces such as capillary action, a pressure difference between the space between the cover window 20 and the display panel 10 and an external space, and surface tension between molecules of the nonpolar liquid 30 may act on the nonpolar liquid 30. Accordingly, the nonpolar liquid 30 may not leak out of the region between the cover window 20 and the display panel 10. The size of the gap Gap1 may be small enough to prevent the nonpolar liquid 30 from leaking out of the region between the cover window 20 and the display panel 10 due to capillary action, pressure difference, or surface tension.

The cover window 20, the display panel 10, and an air layer may have different refractive indices. When an air layer is present between the cover window 20 and the display panel 10, visibility may be degraded due to a difference in refractive index. In the display device 1 according to the embodiment, the nonpolar liquid 30 may be positioned between the cover window 20 and the display panel 10 in order to reduce the difference in refractive index between the cover window 20 and the display panel 10, thereby improving visibility. The nonpolar liquid 30 may have a refractive index between the refractive index of the display panel 10 and the refractive index of the cover window 20.

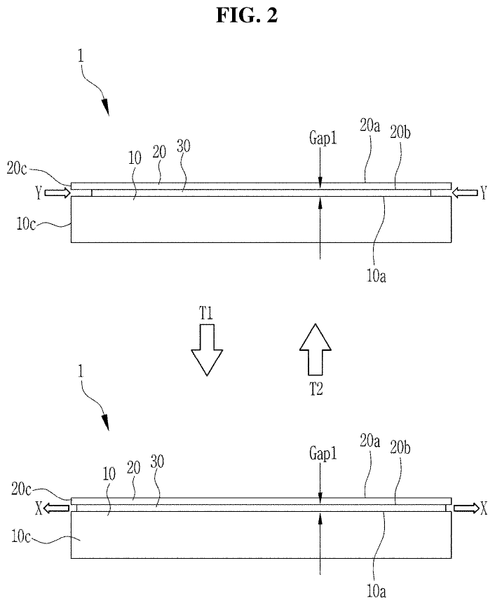

FIG. 2 is a view showing a change in the volume of the nonpolar liquid 30 in the display device 1.

The display panel 10 may generate heat during operation depending on the type thereof. The display device 1 may be used in a relatively high-temperature environment. As the temperature of the nonpolar liquid 30 increases, the volume of the nonpolar liquid 30 may increase.

In the display device 1, the nonpolar liquid 30 is positioned between the cover window 20 and the display panel 10 using forces such as capillary action, pressure difference, and surface tension. The upper surface of the nonpolar liquid 30 is in contact with the cover window 20, the lower surface of the nonpolar liquid 30 is in contact with the display panel 10, and the side surface of the nonpolar liquid 30 is exposed. In the display device 1, the edge of the space defined between the cover window 20 and the display panel 10 is not sealed. That is, the nonpolar liquid 30 is in a state in which the side surface thereof is exposed. In this configuration, the side surface of the nonpolar liquid 30 refers to a surface that is oriented in the same direction as the side surface 20c of the cover window 20 and the side surface 10c of the display panel 10.

When the temperature of the nonpolar liquid 30 increases (arrow T1), the volume of the nonpolar liquid 30 may increase, as indicated by arrow X in FIG. 2. In this case, the area of the nonpolar liquid 30 may increase with the gap between the display panel 10 and the cover window 20 maintained. Conversely, when the temperature of the nonpolar liquid 30 decreases (arrow T2), the volume of the nonpolar liquid 30 may decrease, as indicated by arrow Y in FIG. 2. In this case, the area of the nonpolar liquid 30 may decrease with the gap between the display panel 10 and the cover window 20 maintained.

In a structure in which the side surface of the nonpolar liquid 30 is sealed, a change in the volume of the nonpolar liquid 30 may cause a variation in the gap between the cover window 20 and the display panel 10 or damage to the sealing structure, such as breakage of the sealing structure. Such a variation in the gap or breakage of the sealing structure may degrade visibility.

However, in the display device 1 according to the embodiment, the side surface of the nonpolar liquid 30 is exposed, whereby visibility may be maintained even when the volume of the nonpolar liquid 30 changes.

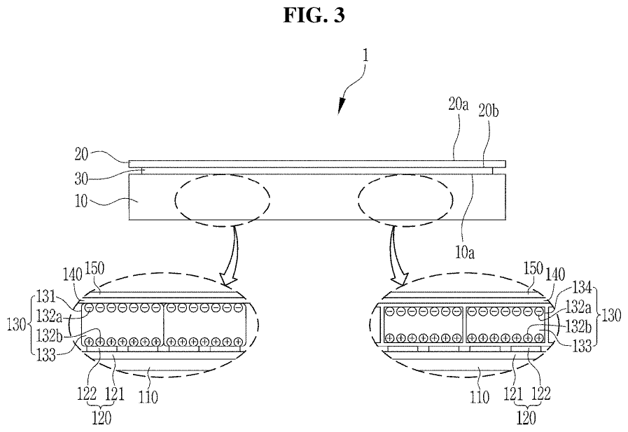

FIG. 3 is a view showing the display panel 10 according to an embodiment.

The display panel 10 may be an electrophoretic display panel. The display panel 10 may include a lower substrate 110, a lower electrode layer 120 formed on the lower substrate 110, a display layer 130 formed on the lower electrode layer 120 and configured to display information through movement of electrophoretic particles 132a and 132b, an upper electrode layer 140 formed on the display layer 130, and an upper substrate 150 formed on the upper electrode layer 140.

The lower substrate 110 may support the display panel 10.

The lower electrode layer 120 may be formed on the lower substrate 110. The lower electrode layer 120 may include a signal transmission layer 121 and a plurality of lower electrodes 122 formed on an upper side of the signal transmission layer 121. The signal transmission layer 121 may transmit an electrical signal to each of the plurality of lower electrodes 122. One lower electrode 122 or a plurality of lower electrodes 122 may operate as a pixel.

The display layer 130 may include a capsule structure 131 or a partition wall structure 134 therein. The capsule structure 131 may contain a plurality of particles 132a and 132b that exhibit colors and a fluid 133 in which the particles 132a and 132b are movable. The particles 132a and 132b may have a negative or positive electric charge. The particles 132a and 132b may move in response to an electric field generated between the upper electrode and the lower electrodes 122. If the first particles 132a or the second particles 132b move toward the upper substrate 150 according to the direction of the electric field, the colors of the particles 132a or 132b that have moved toward the upper substrate 150 may be displayed to the outside.

The partition wall structure 134 may form a plurality of compartments that contain a plurality of particles 132a and 132b and a fluid 133. The partition wall structure 134 may alternatively be formed in a cup-shaped structure. The fluid 133 and the plurality of particles 132a and 132b may be contained in the plurality of compartments formed by the partition wall structure 134.

The upper electrode layer 140 may be formed on an upper side of the display layer 130. The upper electrode layer 140 may be formed as a single electrode. Even though the upper electrode layer 140 is formed as a single electrode, because the lower electrode layer 120 includes the plurality of lower electrodes 122, the direction of the electric field in each region may be varied depending on the electrical signal applied to each of the lower electrodes 122. The upper electrode layer 140 may be formed of a material that is transparent in the visible spectrum. In some cases, the upper electrode layer 140 may be formed of a material that is transparent in various wavelength bands.

The upper substrate 150 may be formed on the upper electrode layer 140. The upper substrate 150 may be formed of a transparent material. The upper substrate 150 may protect and electrically insulate the upper electrode layer 140.

The display panel 10 may further include an insulating layer or an adhesive layer in addition to the lower substrate 110, the lower electrode layer 120, the display layer 130, the upper electrode layer 140, and the upper substrate 150.

When the display panel 10 employs a display type other than the electrophoretic display, the display panel 10 may further include an emission layer, a light diffusion layer, and other necessary components.

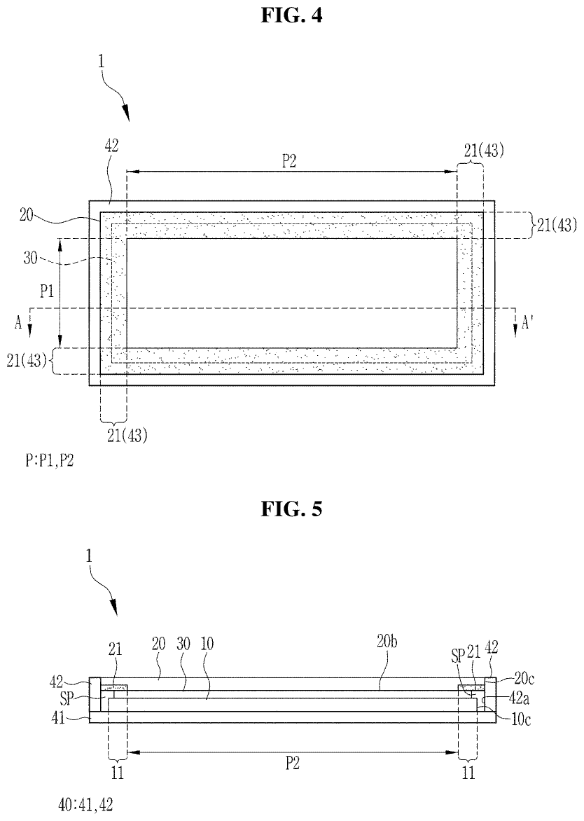

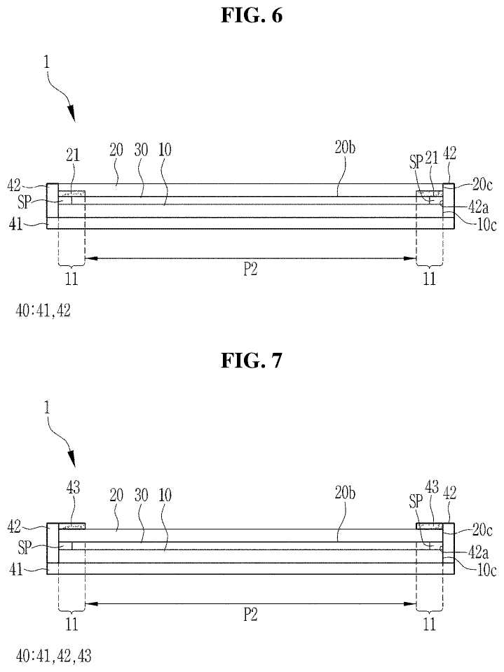

FIG. 4 is a plan view of the display device 1 including the nonpolar liquid 30 according to the embodiment. FIG. 5 is a cross-sectional view taken along line A-A′ in FIG. 4 to show a structure in which the side surface 10c of the display panel 10 is spaced apart from a side case 42. FIG. 6 is a cross-sectional view taken along line A-A′ in FIG. 4 to show a structure in which the side surface 10c of the display panel 10 is in contact with the side case 42. FIG. 7 is a cross-sectional view taken along line A-A′ in FIG. 4 to show a case 40 including a case bezel 43.

The display device 1 may further include a case 40 configured to accommodate and fix the display panel 10 and the cover window 20 spaced apart by a predetermined gap (refer to Gap1 in FIG. 1). The case 40 may include a lower case 41 configured to fix the display panel 10 and a side case 42 connected to the lower case 41 and configured to fix the cover window 20.

The case 40 may accommodate the display panel 10 and the cover window 20. The side case 42 may fix the cover window 20. The side surface 20c of the cover window 20 may be in contact with and fixed to an inner surface 40a of the case 40. The lower case 41 may fix the display panel 10. The case 40 may fix the display panel 10 and the cover window 20 such that the predetermined gap Gap1 is defined between the display panel 10 and the cover window 20. Various other structures may be employed to fix the cover window 20 to the case 40 and to fix the display panel 10 to the case 40.

As shown in FIGS. 4 and 5, the side surface 10c of the display panel 10 and the inner surface 40a of the case 40 may be spaced apart from each other. When the side surface 10c of the display panel 10 and the inner surface 40a of the case 40 are spaced apart from each other, a space SP may be defined therebetween. The space SP may be connected to the side surface of the nonpolar liquid 30. When the volume of the nonpolar liquid 30 changes, the area of the nonpolar liquid 30 may increase or decrease using the space SP.

As shown in FIGS. 4, 6, and 7, the inner surface 40a of the case 40 may be in close contact with the side surface 10c of the display panel 10. In this case, because the side surface 10c of the display panel 10 is in contact with the inner surface 40a of the case 40, the space SP may be limited to the region between the cover window 20 and the display panel 10. When the volume of the nonpolar liquid 30 changes, the area of the nonpolar liquid 30 may increase or decrease using the space SP.

As shown in FIGS. 4 and 7, the case 40 may further include a case bezel 43 connected to the side case 42 and configured to cover a panel bezel 11 corresponding to an area peripheral to an active area P of the display panel 10 in order to prevent the panel bezel 11 from being exposed to the outside. The case bezel 43 is a portion that protrudes from the side case 42 toward the active area P of the display device 1 to cover an edge of the display panel 10. The case bezel 43 may cover and fix an edge of the upper surface 20a of the cover window 20.

The display panel 10 may include an active area P configured to display information and a panel bezel 11 positioned outside an edge of the active area P. The active area P is a portion that is exposed to the outside so as to be visible to a user. Referring to FIG. 4, the active area P may be indicated by a horizontal length P2 and a vertical length P1. The panel bezel 11 is a region in which components such as wires necessary for displaying information through the active area P are disposed, that is, a region that does not display information. Therefore, the panel bezel 11 may be covered so as not to be visible from the outside. The case bezel 43 may cover the panel bezel 11. The case bezel 43 may cover the panel bezel 11 without covering the active area P.

As shown in FIGS. 4, 5, and 6, the display device 1 may further include a bezel coating 21 formed at an edge of the cover window 20 to cover the panel bezel 11 corresponding to an area peripheral to the active area P of the display panel 10 in order to prevent the panel bezel 11 from being exposed to the outside. The bezel coating 21 is a layer with a very small thickness coated on the lower surface 20b of the cover window 20. However, in the drawings of the present disclosure, the bezel coating 21 is illustrated with an exaggerated thickness inward of the lower surface 20b of the cover window 20 for the purpose of distinguishing the same from other components.

The bezel coating 21 may be formed to cover the panel bezel 11. The bezel coating 21 may be formed at an edge of the lower surface 20b of the cover window 20. The bezel coating 21 may have a single color such as black or white. As shown in FIGS. 5 and 6, when the case 40 does not include the case bezel 43, the display device 1 may further include the bezel coating 21. In contrast, as shown in FIG. 7, when the case 40 includes the case bezel 43, the bezel coating 21 may be omitted.

As shown in FIGS. 4 to 7, the region in which the nonpolar liquid 30 is positioned may be set to be larger than the active area P of the display panel 10 but smaller than the display panel 10.

The nonpolar liquid 30 may have a larger area than the active area P but may have a smaller area than the display panel 10. In order to improve visibility of the active area P, the nonpolar liquid 30 may have a larger area than the active area P. The nonpolar liquid 30 needs to have a smaller area than the display panel 10 in order to prevent the nonpolar liquid 30 from overflowing to a side surface of the display panel 10.

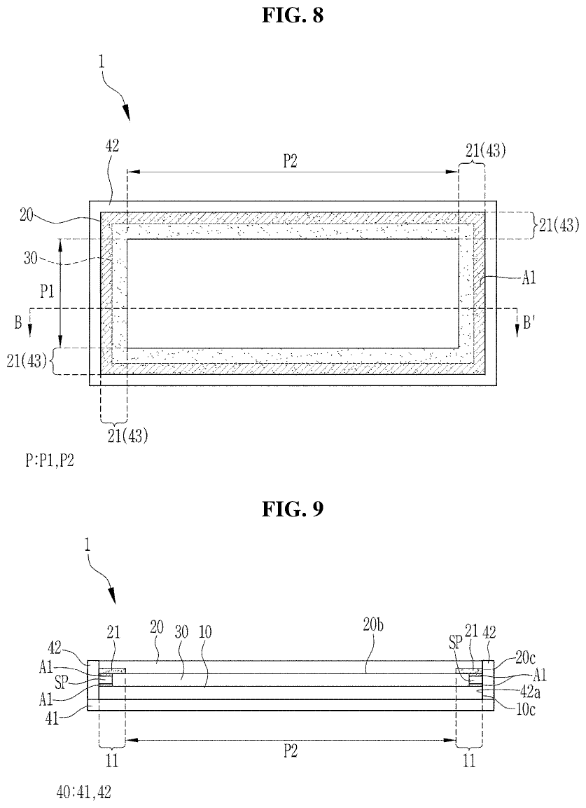

FIG. 8 is a plan view showing an oleophobic region A1 of the display device 1 including the nonpolar liquid 30 according to the embodiment. FIG. 9 is a cross-sectional view taken along line B-B′ in FIG. 8. FIG. 9 shows a structure in which the side surface 10c of the display panel 10 is in contact with the inner surface 40a of the case 40. The active area P, the panel bezel 11, the bezel coating 21, and the space SP shown in FIG. 9 have been described with reference to FIG. 6.

The display device 1 may further include an oleophobic region A1 formed by coating an oleophobic material along an edge of a region in which the nonpolar liquid 30 is to be positioned between the display panel 10 and the cover window 20. The oleophobic region refers to a region coated with a material that is not compatible with the nonpolar liquid 30.

The oleophobic region A1 may be formed on the upper surface 10a of the display panel 10, on the lower surface 20b of the cover window 20, or on both the upper surface 10a of the display panel 10 and the lower surface 20b of the cover window 20. The oleophobic region A1 may be formed by coating a polar molecule. A structure in which the oleophobic region A1 is formed on both the upper surface 10a of the display panel 10 and the lower surface 20b of the cover window 20 may exhibit a stronger tendency for the nonpolar liquid 30 to remain within a region surrounded by the oleophobic region A1 than a structure in which the oleophobic region A1 is formed on only one of the upper surface 10a of the display panel 10 and the lower surface 20b of the cover window 20.

The oleophobic region A1 may be formed in a ring shape so as to surround the region in which the nonpolar liquid 30 is to be positioned. The oleophobic region A1 may have an overall rectangular ring shape. The oleophobic region A1 may be formed along the edge of the upper surface 10a of the display panel 10 or along the edge of the lower surface 20b of the cover window 20.

The oleophobic region A1 may be formed along an outer edge of the region in which the case bezel 43 or the bezel coating 21 is formed, close to the case 40. The oleophobic region A1 may be formed along the edge of the display panel 10 on the panel bezel 11. Because the region in which the nonpolar liquid 30 is positioned is slightly larger than the active area P, the nonpolar liquid 30 may also be positioned on the panel bezel 11.

Because the nonpolar liquid 30 is relatively unstable when positioned in the oleophobic region A1, the nonpolar liquid 30 may be confined within the space SP surrounded by the oleophobic region A1. The nonpolar liquid 30 may be positioned in an overall rectangular shape defined by the oleophobic region A1, which has a rectangular ring shape slightly larger than the active area P. When the temperature of the nonpolar liquid 30 increases, the nonpolar liquid 30 may expand and intrude into the oleophobic region A1, but when the temperature of the nonpolar liquid 30 decreases, the nonpolar liquid 30 may contract back in a direction from the oleophobic region A1 toward the active area P. As such, the oleophobic region A1 may prevent the nonpolar liquid 30 from leaking out of the space SP between the display panel 10 and the cover window 20.

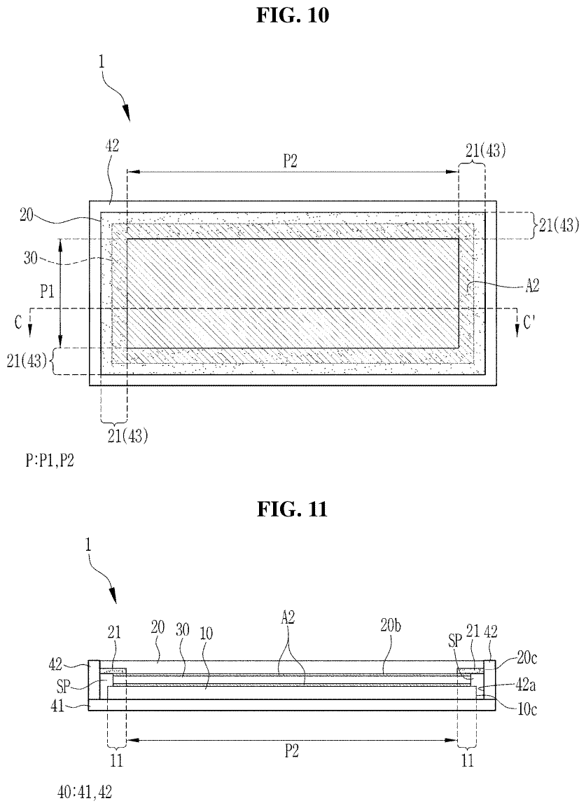

FIG. 10 is a plan view showing an oleophilic region A2 of the display device 1 including the nonpolar liquid 30 according to the embodiment. FIG. 11 is a cross-sectional view taken along line C-C′ in FIG. 10. FIG. 11 shows a structure in which the side surface 10c of the display panel 10 is spaced apart from the inner surface 40a of the case 40. The active area P, the panel bezel 11, the bezel coating 21, and the space SP shown in FIG. 11 have been described with reference to FIG. 5.

The display device 1 may further include an oleophilic region A2 formed by coating an oleophilic material in the region in which the nonpolar liquid 30 is to be positioned between the display panel 10 and the cover window 20. The oleophilic region refers to a region coated with a material that is compatible with the nonpolar liquid 30.

The oleophilic region A2 may be formed on the upper surface 10a of the display panel 10, on the lower surface 20b of the cover window 20, or on both the upper surface 10a of the display panel 10 and the lower surface 20b of the cover window 20. The oleophilic region A2 may be formed by coating a nonpolar molecule. A structure in which the oleophilic region A2 is formed on both the upper surface 10a of the display panel 10 and the lower surface 20b of the cover window 20 may exhibit a stronger tendency for the nonpolar liquid 30 to remain within the oleophilic region A2 than a structure in which the oleophilic region A2 is formed on only one of the upper surface 10a of the display panel 10 and the lower surface 20b of the cover window 20.

The oleophilic region A2 may be formed in the same region as the region in which the nonpolar liquid 30 is to be positioned. The oleophilic region A2 may be formed in an overall rectangular shape. Because the active area P is generally formed in a rectangular shape, the oleophilic region A2, which is formed in the same region as the region in which the nonpolar liquid 30 is to be positioned, may also be formed in a rectangular shape. The oleophilic region A2 may be formed in the middle of the upper surface 10a of the display panel 10 or may be formed in the middle of the lower surface 20b of the cover window 20.

The oleophilic region A2 may be formed along an inner edge of the region in which the case bezel 43 or the bezel coating 21 is formed, close to the active area P, so as to cover the active area P. The oleophilic region A2 may be formed across an inner edge of the panel bezel 11 and the active area P. Because the region in which the nonpolar liquid 30 is positioned is slightly larger than the active area P, the oleophilic region A2 may also be positioned on the panel bezel 11.

Because the nonpolar liquid 30 is relatively stable when positioned in the oleophilic region A2, the nonpolar liquid 30 may be positioned within the oleophilic region A2. The nonpolar liquid 30 may be disposed along the oleophilic region A2, which has a rectangular shape and is slightly larger than the active area P, and thus may have an overall rectangular shape. When the temperature of the nonpolar liquid 30 increases, the nonpolar liquid 30 may expand beyond the oleophilic region A2, but when the temperature of the nonpolar liquid 30 decreases, the nonpolar liquid 30 may contract within the oleophilic region A2. As such, the oleophilic region A2 may prevent the nonpolar liquid 30 from leaking out of the space SP between the display panel 10 and the cover window 20.

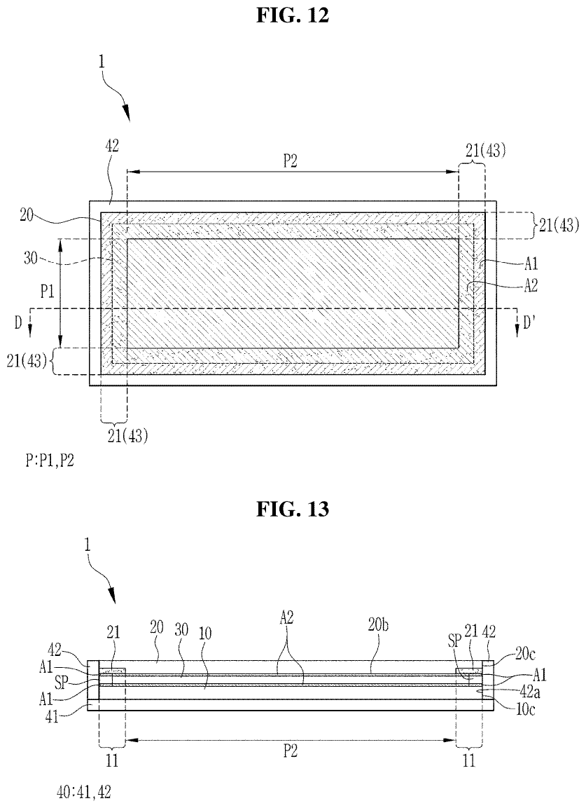

FIG. 12 is a plan view showing the oleophobic region A1 and the oleophilic region A2 of the display device 1 including the nonpolar liquid 30 according to the embodiment. FIG. 13 is a cross-sectional view taken along line D-D′ in FIG. 12. FIG. 13 shows a structure in which the case bezel 43 is present. The active area P, the panel bezel 11, the case bezel 43, and the space SP shown in FIG. 13 have been described with reference to FIG. 7.

In the display device 1, the oleophobic region A1 may be formed by coating an oleophobic material along the edge of the region in which the nonpolar liquid 30 is to be positioned on the surfaces of the display panel 10 and the cover window 20 that face each other, and the oleophilic region A2 may be formed by coating an oleophilic material in the region in which the nonpolar liquid 30 is to be positioned on the surfaces of the display panel 10 and the cover window 20 that face each other.

Detailed descriptions of the oleophobic region A1 described with reference to FIGS. 8 and 9 and the oleophilic region A2 described with reference to FIGS. 10 and 11 will be omitted to avoid redundancy.

The oleophobic region A1 and the oleophilic region A2 may be formed on the upper surface 10a of the display panel 10 or the lower surface 20b of the cover window 20. The oleophobic region A1 and the oleophilic region A2 may be formed on both the upper surface 10a of the display panel 10 and the lower surface 20b of the cover window 20. That is, the oleophobic region A1 may be formed to surround the oleophilic region A2. Because the nonpolar liquid 30 is more stable when positioned within the oleophilic region A2 than when in contact with the oleophobic region A1, the nonpolar liquid 30 may remain in contact with the oleophilic region A2 while avoiding contact with the oleophobic region A1. The oleophobic region A1 and the oleophilic region A2 may restrict the shape of the nonpolar liquid 30. The oleophobic region A1 and the oleophilic region A2 may prevent the nonpolar liquid 30 from leaking out of the display panel 10 and the cover window 20. Accordingly, even in a structure in which the side surface of the nonpolar liquid 30 is exposed, the nonpolar liquid 30 may remain within a prescribed region.

It is to be understood that the oleophobic region A1 and the oleophilic region A2 described with reference to FIGS. 8 to 13 may be applied to any of the structures of the display panel 10 and the case 40 described with reference to FIGS. 5 to 7.

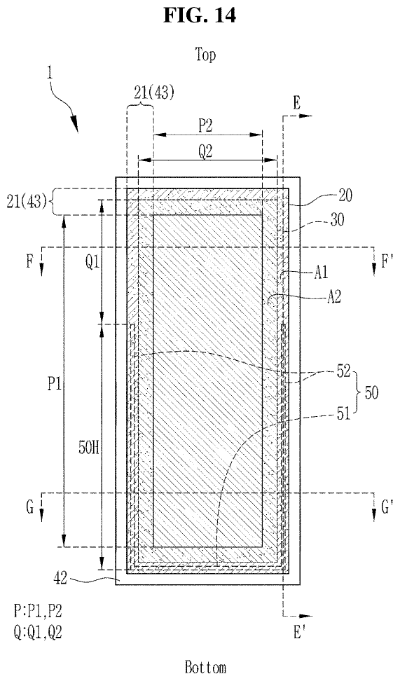

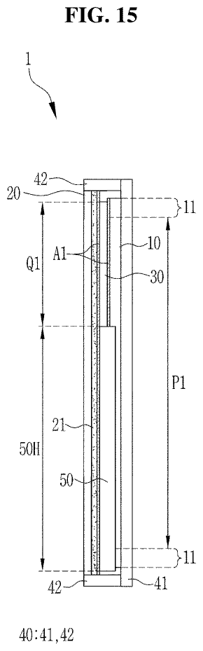

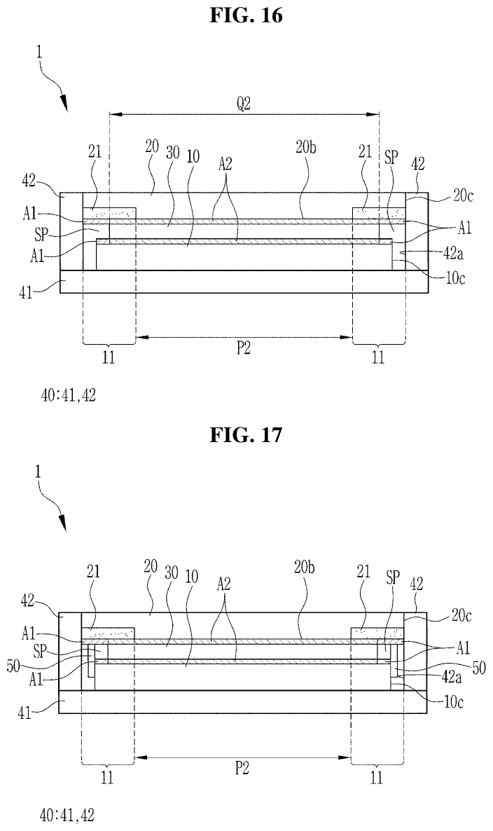

FIG. 14 is a plan view showing a guard 50 of the display device 1 including the nonpolar liquid 30 according to the embodiment. FIG. 15 is a cross-sectional view taken along line E-E′ in FIG. 14. FIG. 16 is a cross-sectional view taken along line F-F′ in FIG. 14. FIG. 17 is a cross-sectional view taken along line G-G′ in FIG. 14.

The display device 1 may further include a guard 50 that is formed along a lower edge of the region in which the nonpolar liquid 30 is positioned that is oriented downward based on the direction of gravity and along at least a portion of lateral edges of the region in which the nonpolar liquid 30 is positioned, thereby preventing leakage of the nonpolar liquid 30.

The display device 1 may be typically used in a specific orientation. For example, a television is typically installed in an orientation in which the horizontal length is greater than the vertical length. For example, a smartphone is typically used in an orientation in which the vertical length is greater than the horizontal length. That is, the display device 1 may have a defined top and bottom. Compared to when the display device is used for a television, the amount of the nonpolar liquid 30 is relatively small when the display device 1 is used for a smartphone. Conversely, the amount of the nonpolar liquid 30 included in the display device 1 for a television is relatively large. When the amount of the nonpolar liquid 30 is large, it may be difficult to confine the nonpolar liquid 30 within a prescribed region using one or more of capillary force, the oleophilic region A2, and the oleophobic region A1. This is because gravitational effects may become more significant as the amount of the nonpolar liquid 30 increases. In such a case, the nonpolar liquid 30 may leak downward through the bottom of the display device 1 due to gravity.

The guard 50 may be formed along the lower edge of the region in which the nonpolar liquid 30 is positioned (the lower side of the display device 1). The guard 50 may be formed along at least a portion of the lateral edges of the region in which the nonpolar liquid 30 is positioned. The lateral edges refer to edges disposed in a lateral direction with respect to the vertical orientation of the display device 1.

The guard 50 may be formed along the lower side and the lateral sides of the display panel 10 based on the top and bottom orientation defined according to the intended use of the display panel 10, and may not be formed along the upper side of the display panel 10. That is, the guard 50 may be formed only along the lower side and the lateral sides of the display panel 10. The guard 50 may not be formed along the upper edge of the region in which the nonpolar liquid 30 is positioned. The upper edge of the region in which the nonpolar liquid 30 is positioned may remain open so that the nonpolar liquid 30 may enter the space SP when the volume of the nonpolar liquid 30 increases due to increase in temperature.

The guard 50 may prevent the nonpolar liquid 30 from leaking downward due to gravity.

Because the guard 50 is formed to surround the lower edge and a portion of the lateral edges of the region in which the nonpolar liquid 30 is positioned, the guard 50 may be covered by the bezel coating 21 or the case bezel 43. Accordingly, the guard 50 may not be exposed to the outside. The guard 50 may be formed between the lower surface 20b of the cover window 20 and the upper surface 10a of the display panel 10. The guard 50 may be formed of melamine, phenol, polyester, silicone, butadiene, butyl, ethyl, PVC, polyurethane, epoxy, rubber, acrylic, or the like.

The height of the guard 50 may be set to a value capable of preventing the nonpolar liquid 30 from leaking through a region Q not blocked by the guard 50 due to gravity.

The region Q in which the nonpolar liquid 30 is not blocked by the guard 50 is indicated by a horizontal length Q2 and a vertical length Q1 in FIG. 14. When an area (Q1×Q2) of the region Q in which the nonpolar liquid 30 is not blocked by the guard 50 is sufficiently small, the position of the nonpolar liquid 30 may be restricted within a prescribed region by capillary force, the oleophobic region A1, and the oleophilic region A2. Therefore, the nonpolar liquid 30 may not leak laterally even under the influence of gravity. As such, the height of the guard 50 may be determined such that the nonpolar liquid 30 positioned in the region Q in which the nonpolar liquid 30 is not blocked by the guard 50 does not leak.

The oleophobic region A1 may not be formed in the region in which the guard 50 is formed. That is, the region in which the nonpolar liquid 30 is positioned may be surrounded by the guard 50 and the oleophobic region A1. Because the guard 50 is formed only up to a predetermined height, a space SP may be defined in a portion in which only the oleophobic region A1 is formed without the guard 50. The nonpolar liquid 30 positioned in the region in which the guard 50 is not formed may be confined within a prescribed region by the oleophobic region A1.

The guard 50 may be formed to connect the side surface 10c of the display panel 10 to the lower surface 20c of the cover window 20. The guard 50 may not be formed between the display panel 10 and the cover window 20. The guard 50 may not be in contact with the nonpolar liquid 30. The oleophobic region A1 may be formed to surround the region in which the nonpolar liquid 30 is to be positioned, and the guard 50 may be formed on the oleophobic region A1. A space SP may be defined between the guard 50 and the nonpolar liquid 30. When the nonpolar liquid 30 temporarily moves due to gravity, impact, inertia, or expansion, the nonpolar liquid 30 may temporarily stay in the space SP and then return to the oleophilic region A2.

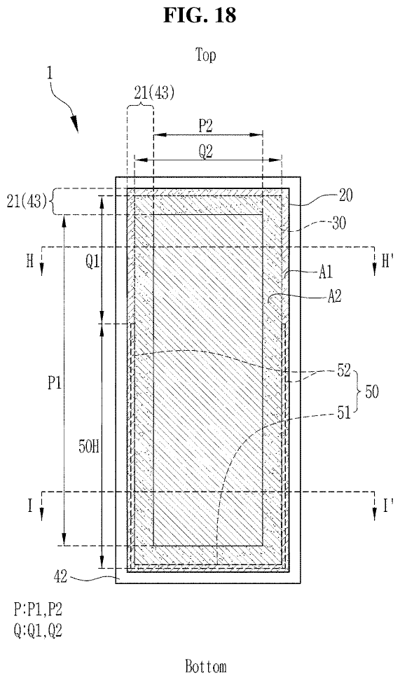

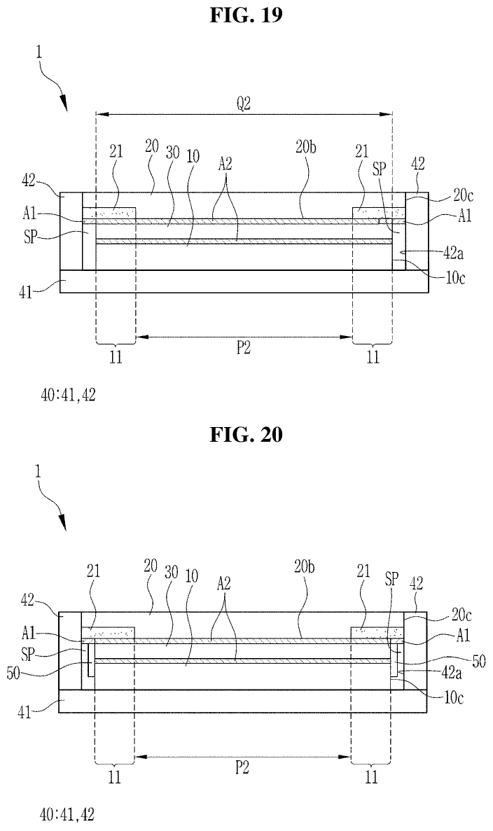

FIG. 18 is a plan view showing a structure in which the guard 50 is in contact with the nonpolar liquid 30 in the display device 1 including the nonpolar liquid 30 according to the embodiment. FIG. 19 is a cross-sectional view taken along line H-H′ in FIG. 18. FIG. 20 is a cross-sectional view taken along line I-I′ in FIG. 18.

The oleophobic region A1 may be formed only on the lower surface 20b of the cover window 20, rather than being formed on the upper surface 10a of the display panel 10. The oleophilic region A2 may be formed on the entire upper surface 10a of the display panel 10. That is, the oleophilic region A2 may be formed over the entire active area P and the entire panel bezel 11. In this case, the region in which the nonpolar liquid 30 is positioned may correspond to the entire upper surface 10a of the display panel 10. Because the guard 50 is formed to connect the side surface 10c of the display panel 10 to the lower surface 20b of the cover window 20, the guard 50 may be in contact with the nonpolar liquid 30.

Even when the space SP is not defined between the guard 50 and the nonpolar liquid 30, the guard 50 may not be formed on either the upper side (top) or a portion of the lateral sides of the display panel 10. Accordingly, when gravitational force, impact, inertia, or expansion is applied to the nonpolar liquid 30, the nonpolar liquid 30 may be temporarily located in the space SP and then return to the oleophilic region A2 due to interaction with the oleophobic region A1.

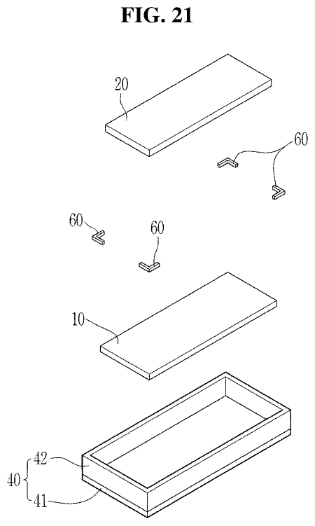

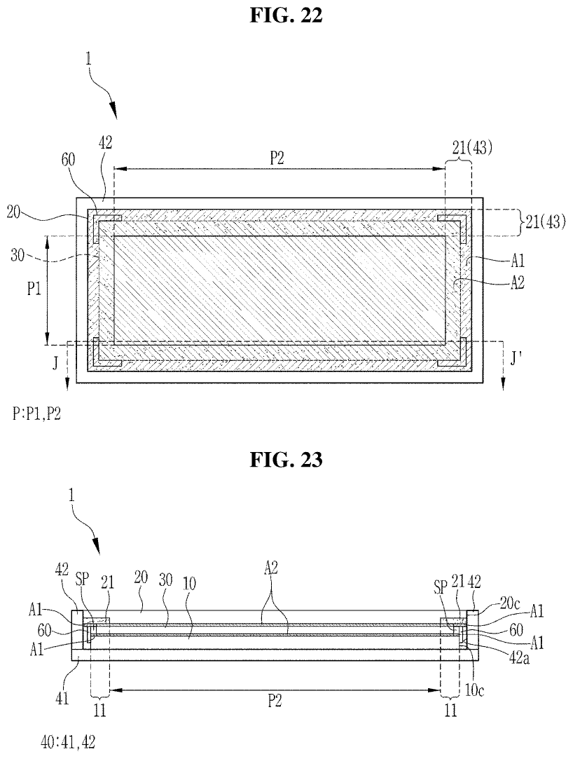

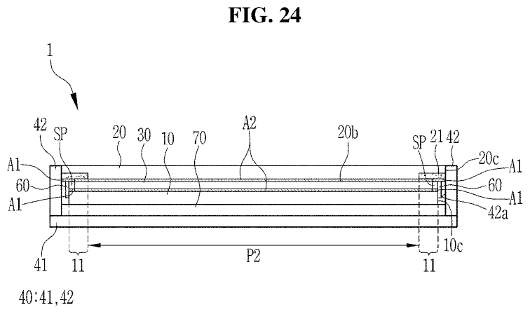

FIG. 21 is an exploded perspective view showing a guide 60 of the display device 1 including the nonpolar liquid 30 according to the embodiment. FIG. 22 is a plan view showing the guide 60 of the display device 1 including the nonpolar liquid 30 according to the embodiment. FIG. 23 is a cross-sectional view taken along line J-J′ in FIG. 22.

The display device 1 may further include a plurality of guides 60, which are connected to the lower surface 20b of the cover window 20 and are in contact with the edge of the display panel 10 to guide the relative position between the display panel 10 and the cover window 20.

The guides 60 may be used when the display panel 10 and the cover window 20 are assembled. The guides 60 may align the active area P of the display panel 10, the bezel coating of the cover window 20, or the case bezel 43 of the case 40. The guides 60 may also maintain a constant distance between the cover window 20 and the display panel 10. Each of the guides 60 may include a latching step, on which a corner of the display panel 10 may be seated, thereby preventing the display panel 10 from moving closer to the cover window 20 than a predetermined gap Gap1. The guides 60 may be disposed inside the case 40. The guides 60 may be connected to the lower case 41.

Each of the guides 60 may be positioned at a respective corner of the display panel 10. Each of the guides 60 may have an overall L-shape. A total of four guides 60 may be provided. Each of the guides 60 may be positioned at a respective edge of the display panel 10. Each of the guides 60 may have a linear shape. The number and shape of the guides 60 may be variously modified.

The guides 60 may be formed on the lower surface 20b of the cover window 20. During assembly of the cover window 20 and the display panel 10, the display panel 10 may be positioned between the plurality of guides 60.

The display device 1 including the guides 60 may have a structure in which the side surface 10c of the display panel 10 and the inner surface 40a of the case 40 are spaced apart from each other to secure a region into which the guides 60 are inserted. The guides 60 may be covered by the bezel coating 21 or the case bezel 43. Before forming the guides 60 on the lower surface 20b of the cover window 20, the oleophobic region A1 may be formed on the lower surface 20b of the cover window 20. Thereafter, the guides 60 may be formed on the oleophobic region A1.

FIG. 24 is a cross-sectional view showing a power supply 70 of the display device 1 including a nonpolar liquid 30 according to the embodiment.

The display device 1 may further include a power supply 70 configured to provide an electrical signal to the display panel 10. The power supply 70 may supply power for operating the display panel 10 and may provide an electrical signal for displaying information on the display panel 10. The power supply 70 may be positioned between the display panel 10 and the lower case 41. The power supply 70 may be accommodated in the case 40. The power supply 70 may alternatively be positioned on the side surface of the display panel 10. The position of the power supply 70 may be variously modified depending on the design of the display device 1.

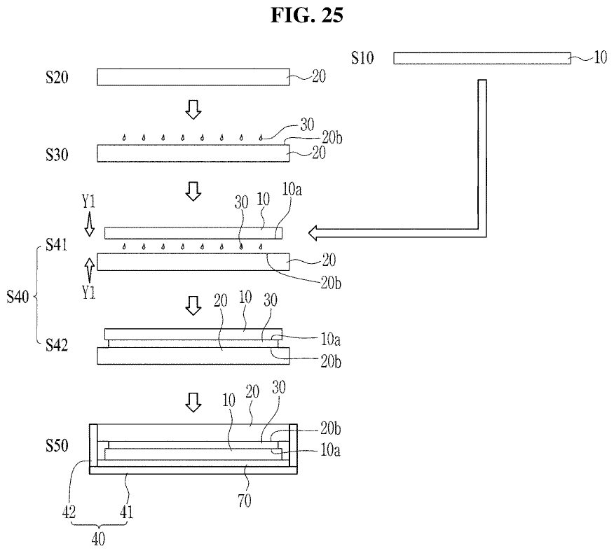

FIG. 25 is a cross-sectional view showing some steps of a method of manufacturing the display device 1 including the nonpolar liquid 30 according to an embodiment.

The method of manufacturing the display device 1 including the nonpolar liquid 30 may include a step of preparing a display panel 10 including an active area P configured to display information and a bezel 11 surrounding the active area P (S10), a step of preparing a cover window 20 (S20), a step of applying a nonpolar liquid 30 to a lower surface 20b of the cover window 20 (S30), a step of coupling the cover window 20 and the display panel 10 such that the nonpolar liquid 30 is positioned between the lower surface 20b of the cover window 20 and an upper surface 10a of the display panel 10 (S40), and a step of assembling a case 40 to accommodate the cover window 20 and the display panel 10 (S50).

The step S10 of preparing a display panel 10 may include fabricating a display panel 10 configured to display information or preparing a display panel 10 that has already been fabricated. In the step S10 of preparing a display panel 10, an electrophoretic display panel may be fabricated as described with reference to FIG. 3. Alternatively, any of various types of display panels such as an LCD, a PDP, and an OLED may be prepared in the step S10 of preparing a display panel 10.

The step S20 of preparing a cover window 20 may include preparing a cover window 20 configured to protect the display panel 10. In the step S20 of preparing a cover window 20, the cover window 20 may be cut to a required size.

The step S30 of applying a nonpolar liquid 30 may include applying a nonpolar liquid 30 to the lower surface 20b of the cover window 20. In the step S30 of applying a nonpolar liquid 30, the cover window 20 may be positioned such that the lower surface 20b thereof is oriented upward. In the step S30 of applying a nonpolar liquid 30, the nonpolar liquid 30 may be dropped onto the lower surface 20b of the cover window 20 in the form of droplets or may be applied to the lower surface 20b of the cover window 20 in a spray manner. The nonpolar liquid 30 may be applied to a region of the lower surface 20b of the cover window 20 in which the nonpolar liquid 30 is to be positioned.

The nonpolar liquid 30 may alternatively be applied to the upper surface 10a of the display panel 10. The display panel 10 may be disposed such that the upper surface 10a thereof is oriented upward, and the nonpolar liquid 30 may be applied within the active area P of the display panel 10.

The step S40 of coupling the cover window 20 and the display panel 10 may include bringing the display panel 10 into close contact with the cover window 20 having the nonpolar liquid 30 applied thereto.

Referring to step S41 in FIG. 25, in a state in which the lower surface 20b of the cover window 20 is oriented upward, the display panel 10 may be disposed such that the upper surface 10a thereof is oriented downward, and the cover window 20 and the display panel 10 may be coupled such that the distance between the lower surface 20b of the cover window 20 and the upper surface 10a of the display panel 10 is a predetermined gap Gap1 (see FIG. 1). As the cover window 20 and the display panel 10 move toward each other in the direction indicated by arrow Y1, the nonpolar liquid 30 may form a layer between the cover window 20 and the display panel 10. The coupling between the cover window 20 and the display panel 10 may refer to connection via the nonpolar liquid 30.

Referring to step S42 in FIG. 25, once the cover window 20 and the display panel 10 are coupled, the nonpolar liquid 30 positioned between the cover window 20 and the display panel 10 may be held within a prescribed region by forces such as capillary action, atmospheric pressure difference, and surface tension.

The step S50 of assembling a case 40 may include accommodating the cover window 20 and the display panel 10 in the case 40. In the step S50 of assembling a case 40, a power supply 70 may be fixed in the case 40, the display panel 10 may be connected to the power supply 70, and the cover window 20 may be fixed to the case 40. In the step S50 of assembling a case 40, the structure in which the display panel 10 and the cover window 20 are coupled may be flipped so that the display panel 10 faces the lower case 41. The step S50 of assembling a case 40 may include assembling a lower case 41 and a side case 42. By performing the step S50 of assembling a case 40, the display panel 10 may be fixed to the power supply 70, and the cover window 20 may be fixed to the side case 42, so that the display panel 10 and the cover window 20 may be connected while maintaining the predetermined gap Gap1 (see FIG. 1) therebetween.

According to the method of manufacturing the display device 1 including the nonpolar liquid 30, the display device 1 in which a side surface of the nonpolar liquid 30 remains exposed may be manufactured.

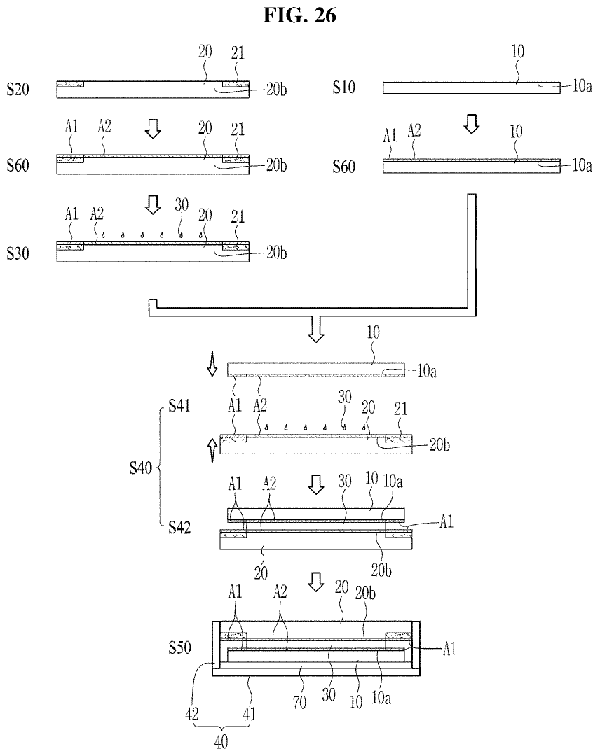

FIG. 26 is a cross-sectional view showing some steps of a method of manufacturing the display device 1 including the nonpolar liquid 30 according to the embodiment, which further includes the guard 50.

Detailed descriptions of a step of preparing a display panel 10 (S10) and a step of preparing a cover window 20 (S20) will be omitted to avoid redundancy.

The step S20 of preparing a cover window 20 may include forming a bezel coating 21 on the lower surface 20b of the cover window 20. As shown in FIGS. 4 to 6, the bezel coating 21 may be formed to expose only the active area P of the display panel 10. The bezel coating 21 may be formed by coating a black or white pigment or paint. As shown in FIG. 7, when the case 40 includes the case bezel 43, the bezel coating 21 may not be formed.

The method of manufacturing the display device 1 including the nonpolar liquid 30 may further include, before a step of coupling the cover window 20 and the display panel 10 (S40), a step of performing coating (S60). The step S60 of performing coating may include a step of forming an oleophobic region A1 and a step of forming an oleophilic region A2. The step of performing coating may be performed on both the display panel 10 and the cover window 20.

The method of manufacturing the display device 1 including the nonpolar liquid 30 may further include, before the step S40 of coupling the cover window 20 and the display panel 10, a step of forming an oleophobic region A1 by coating an oleophobic material on the lower surface 20b of the cover window 20 or the upper surface 10a of the display panel 10 so as to surround a region in which the nonpolar liquid 30 is to be positioned.

In the step of forming the oleophobic region A1, the oleophobic region A1 may be formed on the upper surface 10a of the display panel 10, on the lower surface 20b of the cover window 20, or on both the upper surface 10a of the display panel 10 and the lower surface 20b of the cover window 20.

The method of manufacturing the display device 1 including the nonpolar liquid 30 may further include, before the step S40 of coupling the cover window 20 and the display panel 10, a step of forming the oleophilic region A2 by coating an oleophilic material in a region in which the nonpolar liquid 30 is to be positioned on the lower surface 20b of the cover window 20 or the upper surface 10a of the display panel 10.

In the step of forming the oleophilic region A2, the oleophilic region A2 may be formed on the upper surface 10a of the display panel 10, on the lower surface 20b of the cover window 20, or on both the upper surface 10a of the display panel 10 and the lower surface 20b of the cover window 20.

The step of forming the oleophobic region A1 and the step of forming the oleophilic region A2 may be performed independently. Only one of the step of forming the oleophobic region A1 and the step of forming the oleophilic region A2 may be performed. Even when both the step of forming the oleophobic region A1 and the step of forming the oleophilic region A2 are performed, the oleophobic region A1 or the oleophilic region A2 may be formed on only one of the upper surface 10a of the display panel 10 and the lower surface 20b of the cover window 20.

For example, as shown in FIGS. 8 and 9, the oleophobic region A1 may be formed on both the display panel 10 and the cover window 20, but the oleophilic region A2 may not be formed thereon. As shown in FIGS. 10 and 11, the oleophilic region A2 may be formed on both the display panel 10 and the cover window 20, but the oleophobic region A1 may not be formed thereon. As shown in FIGS. 12 and 13, both the oleophilic region A2 and the oleophobic region A1 may be formed on the display panel 10 and the cover window 20. As shown in FIGS. 18, 19, and 20, the oleophobic region A1 may be formed only on the cover window 20 without being formed on the display panel 10, and the oleophilic region A2 may be formed on both the cover window 20 and the display panel 10.

Although not shown in the drawings, only the oleophilic region A2 may be formed on the cover window 20, and only the oleophobic region A1 may be formed on the display panel 10. Conversely, only the oleophobic region A1 may be formed on the cover window 20, and only the oleophilic region A2 may be formed on the display panel 10.

The step S30 of applying a nonpolar liquid 30 may include applying the nonpolar liquid 30 to the oleophilic region A2 formed on the lower surface 20b of the cover window 20. In the step S30 of applying a nonpolar liquid 30, when the oleophilic region A2 is formed on the lower surface 20b of the cover window 20 or on the upper surface 10a of the display panel 10, the nonpolar liquid 30 may be applied onto the oleophilic region A2. When only the oleophobic region A1 is formed on the lower surface 20b of the cover window 20 or on the upper surface 10a of the display panel 10, the nonpolar liquid 30 may be applied to the lower surface 20b of the cover window 20 or to the upper surface 10a of the display panel 10.

In the step S40 of coupling the cover window 20 and the display panel 10, the cover window 20 and the display panel 10 may be brought into close contact with each other in a state in which the oleophobic region A1 and the oleophilic region A2 formed on the lower surface 20b of the cover window 20 and the oleophobic region A1 and the oleophilic region A2 formed on the upper surface 10a of the display panel 10 are positioned to face each other. A layer of the nonpolar liquid 30 may be formed within the oleophilic region A2. A layer of the nonpolar liquid 30 may be formed within a region surrounded by the oleophobic region A1.

Detailed descriptions of a step of assembling a case 40 (S50) will be omitted to avoid redundancy.

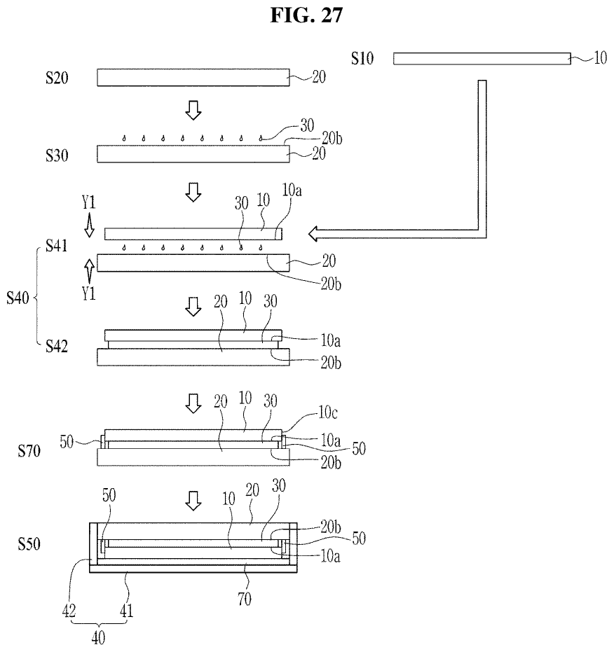

FIG. 27 is a cross-sectional view showing some steps of a method of manufacturing the display device 1 including the nonpolar liquid 30 according to the embodiment, which includes the oleophobic region A1 and the oleophilic region A2.

Detailed descriptions of a step of preparing a display panel 10 (S10), a step of preparing a cover window 20 (S20), a step of applying a nonpolar liquid 30 (S30), and a step of coupling the cover window 20 and the display panel 10 (S40) will be omitted to avoid redundancy.

The method of manufacturing the display device 1 including the nonpolar liquid 30 may further include, after the step S40 of coupling the cover window 20 and the display panel 10, a step of forming a guard 50 configured to connect the lower surface 20b of the cover window 20 to the side surface 10c of the display panel 10 (S70).

The step S70 of forming a guard 50 may be performed after the display panel 10 and the cover window 20 are coupled.

In the method of manufacturing the display device 1 including the nonpolar liquid 30 according to the embodiment, the guard 50 is not formed in advance on the upper surface 10a of the display panel 10 before the cover window 20 is coupled to the display panel 10. If the guard 50 is formed in advance on the upper surface 10a of the display panel 10 and then the cover window 20 is coupled to the display panel 10, the guard 50 may be positioned between the display panel 10 and the cover window 20. In this case, air bubbles may be generated between the nonpolar liquid 30 and the guard 50. In addition, because it is difficult to accurately control the height of the guard 50, it may be difficult to adjust the distance between the display panel 10 and the cover window 20 to the predetermined gap Gap 1 (see FIG. 1).

Because the step S70 of forming a guard 50 according to the embodiment is performed after the cover window 20 and the display panel 10 are coupled, the guard 50 may not be formed in the space between the cover window 20 and the display panel 10. Because the guard 50 is formed in a state in which the cover window 20 and the display panel 10 are coupled via the nonpolar liquid 30, the guard 50 may be formed in a structure of connecting the side surface 10c of the display panel 10 to the lower surface 20b of the cover window 20.

In the step S70 of forming a guard 50, the guard 50 may be formed along the lower side and the lateral sides of the display panel 10 based on the top and bottom orientation defined according to the intended use of the display panel 10, and may not be formed along the upper side of the display panel 10. As described above with reference to FIGS. 14 to 17, the guard 50 may not be in contact with the nonpolar liquid 30. A space may be defined between the guard 50 and the side surface of the nonpolar liquid 30.

Detailed descriptions of a step of assembling a case 40 (S50) will be omitted to avoid redundancy.

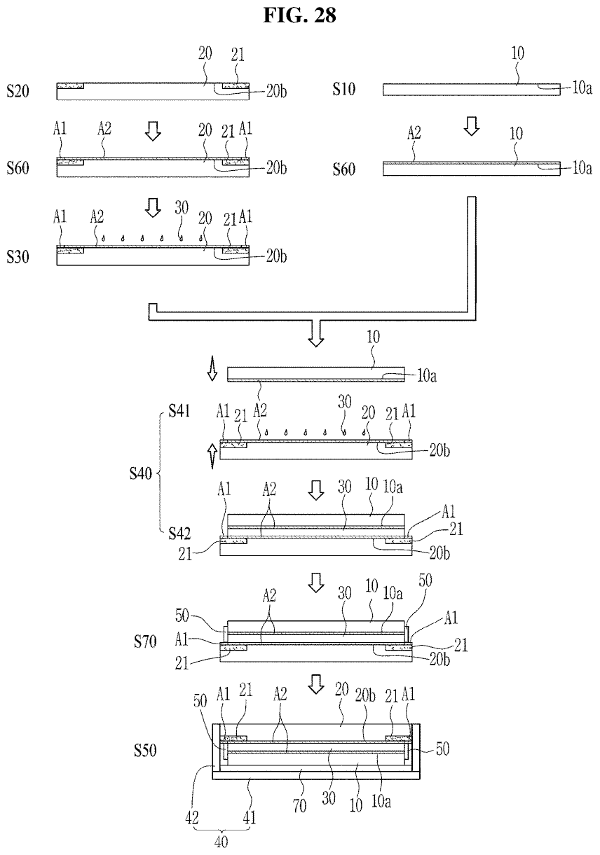

FIG. 28 is a cross-sectional view showing some steps of a method of manufacturing the display device 1 including the nonpolar liquid 30 according to the embodiment, which includes the guard 50, the oleophobic region A1, and the oleophilic region A2.

Detailed descriptions of a step of preparing a display panel 10 (S10) and a step of preparing a cover window 20 (S20) will be omitted to avoid redundancy.

The method of manufacturing the display device 1 including the nonpolar liquid 30 may further include a step of performing coating (S60) (including a step of forming an oleophobic region A1 and a step of forming an oleophilic region A2) and a step of forming a guard 50 (S70).

Detailed descriptions of the step of forming an oleophobic region A1 and the step of forming an oleophilic region A2 will be omitted to avoid redundancy. In the step of forming an oleophobic region A1, the oleophobic region A1 may be formed only on the cover window 20 without being formed on the display panel 10. In the step of forming an oleophilic region A2, the oleophilic region A2 may be formed on the entire upper surface 10a of the display panel 10. In the step of forming an oleophilic region A2, the oleophilic region A2 may be formed on a region of the lower surface 20b of the cover window 20 in which the nonpolar liquid 30 is to be positioned.

In a step of applying a nonpolar liquid 30 (S30), the nonpolar liquid 30 may be applied onto the oleophilic region A2 of the cover window 20, and then a step of coupling the cover window 20 and the display panel 10 (S40) may be performed. The nonpolar liquid 30 may form a layer along the oleophilic region A2, and the side surface of the nonpolar liquid 30 may be formed at the same position as the side surface 10c of the display panel 10.

In the step S70 of forming a guard 50, the guard 50 may be formed to connect the side surface 10c of the display panel 10 to the lower surface 20b of the cover window 20. Because the side surface of the nonpolar liquid 30 is formed on the same line as the side surface 10c of the display panel 10, the side surface of the nonpolar liquid 30 may be in contact with the guard 50. Because the nonpolar liquid 30 has already formed a layer in a predetermined region, no air bubbles are generated between the nonpolar liquid 30 and the guard 50 during the subsequent process of forming the guard 50. If the nonpolar liquid 30 is injected after formation of the guard 50, air bubbles may be generated. However, according to the method of manufacturing the display device 1 including the nonpolar liquid 30 according to the embodiment, the guard 50 is formed after the nonpolar liquid 30 has formed a layer, so air bubbles may not be generated in the nonpolar liquid 30.

Detailed descriptions of a step of assembling a case 40 (S50) will be omitted to avoid redundancy.

As is apparent from the above description, according to an embodiment of the present disclosure, a nonpolar liquid may be disposed between the display panel and the cover window to improve visibility.

According to an embodiment of the present disclosure, it may be possible to prevent changes in visibility due to variation in the volume of the nonpolar liquid.

According to an embodiment of the present disclosure, the position of the nonpolar liquid may be restricted without the necessity to seal the nonpolar liquid.

According to an embodiment of the present disclosure, it may be possible to prevent leakage of the nonpolar liquid due to gravity.

Although exemplary embodiments of the present disclosure have been illustrated and described in order to exemplify the principle of the present disclosure, the present disclosure is not limited to the exemplary embodiments. It will be understood that various modifications and changes can be made by those skilled in the art without departing from the spirit and scope of the disclosure as defined by the appended claims.

What is claimed is:

1. A display device including a nonpolar liquid, comprising:
a display panel;
a cover window spaced apart from the display panel by a predetermined gap; and
a nonpolar liquid positioned between the display panel and the cover window.

2. The display device according to claim 1, further comprising a case configured to accommodate and fix the display panel and the cover window so as to maintain the predetermined gap between the display panel and the cover window,
wherein the case comprises:
a lower case configured to fix the display panel; and
a side case connected to the lower case and configured to fix the cover window.

3. The display device according to claim 2, wherein the case further comprises a case bezel connected to the side case and configured to cover a panel bezel corresponding to an edge of an active area of the display panel so as to prevent exposure of the panel bezel to an outside.

4. The display device according to claim 1, wherein the nonpolar liquid is positioned in a region larger than an active area of the display panel but smaller than the display panel.

5. The display device according to claim 1, further comprising a bezel coating formed at an edge of the cover window and configured to cover a panel bezel corresponding to an edge of an active area of the display panel so as to prevent exposure of the panel bezel to an outside.

6. The display device according to claim 1, further comprising an oleophobic region formed by coating an oleophobic material along an edge of a region configured to receive the nonpolar liquid between the display panel and the cover window.

7. The display device according to claim 6, wherein the oleophobic region is formed on an upper surface of the display panel, on a lower surface of the cover window, or on both the upper surface of the display panel and the lower surface of the cover window.

8. The display device according to claim 1, further comprising an oleophilic region formed by coating an oleophilic material in a region configured to receive the nonpolar liquid between the display panel and the cover window.

9. The display device according to claim 8, wherein the oleophilic region is formed on an upper surface of the display panel, on a lower surface of the cover window, or on both the upper surface of the display panel and the lower surface of the cover window.

10. The display device according to claim 1, further comprising a guard configured to prevent leakage of the nonpolar liquid, the guard being formed along a lower edge of a region having the nonpolar liquid positioned therein based on a direction of gravity and along at least a portion of lateral edges of the region.

11. The display device according to claim 10, wherein the guard has a height determined to prevent the nonpolar liquid from leaking through a region not blocked by the guard due to gravity.

12. The display device according to claim 10, wherein the guard is formed along a lower side and lateral sides of the display panel based on a top and bottom orientation defined according to intended use of the display panel, and is not formed along an upper side of the display panel.

13. The display device according to claim 10, wherein the guard is formed to connect a side surface of the display panel to a lower surface of the cover window, and is not formed between the display panel and the cover window.

14. The display device according to claim 1, further comprising a plurality of guides connected to a lower surface of the cover window and in contact with an edge of the display panel to guide a relative position between the display panel and the cover window.

15. The display device according to claim 1, wherein the display panel comprises:
a lower substrate;
a lower electrode layer formed on the lower substrate;
a display layer formed on the lower electrode layer and configured to display information through movement of electrophoretic particles;
an upper electrode layer formed on the display layer; and
an upper substrate formed on the upper electrode layer.

16. A method of manufacturing a display device including a nonpolar liquid, the method comprising:
preparing a display panel comprising an active area configured to display information and a bezel surrounding the active area;
preparing a cover window;
applying a nonpolar liquid to a lower surface of the cover window;
coupling the cover window and the display panel to allow the nonpolar liquid to be positioned between a lower surface of the cover window and an upper surface of the display panel; and
assembling a case to accommodate the cover window and the display panel.

17. The method according to claim 16, further comprising, before coupling the cover window and the display panel, forming an oleophobic region by coating an oleophobic material on the lower surface of the cover window or on the upper surface of the display panel so as to surround a region configured to receive the nonpolar liquid.

18. The method according to claim 16, further comprising, before coupling the cover window and the display panel, forming an oleophilic region by coating an oleophilic material in a region configured to receive the nonpolar liquid on the lower surface of the cover window or the upper surface of the display panel.

19. The method according to claim 16, further comprising, after coupling the cover window and the display panel, forming a guard configured to connect the lower surface of the cover window to a side surface of the display panel.

20. The method according to claim 19, wherein forming the guard comprises forming the guard along a lower side and lateral sides of the display panel based on a top and bottom orientation defined according to intended use of the display panel without forming the guard along an upper side of the display panel.
